(19) United States
(12) Patent Application Publication
(10) Pub. No.: US 2023/0137370 A1
(43) Pub. Date: May 4, 2023

(54) Rear View Mirror Arrangement for a Vehicle

(71) Applicant: Bayerische Motoren Werke Aktiengesellschaft, Muenchen (DE)

(72) Inventors: Markus BAUDERMANN, Muenchen (DE); Andreas SCHLAYER, Muenchen (DE)

(21) Appl. No.: 17/801,550

(22) PCT Filed: Apr. 1, 2021
(86) PCT No.: PCT/EP2021/058673

§ 371 Date: Aug. 23, 2022

(30) Foreign Application Priority Data
May 25, 2020 (DE) 10 2020 113 913.6

(51) Int. Cl. B60R 1/06

(52) U.S. Cl. CPC B60R 1/06

(57) ABSTRACT

A rearview mirror arrangement for a vehicle has a mirror element and a housing that accommodates the mirror element. The housing has an inner surface, on which at least one fastening extension is formed. The mirror element is connected with a rear side facing the inner surface to the at least one fastening extension. The mirror element is connected to a support element which is formed on the housing for supporting the mirror element at least in some sections.

### BACKGROUND AND SUMMARY

The invention relates to a rear view mirror arrangement for a vehicle, in particular for a tilting vehicle, with a mirror element and a housing that accommodates the mirror element.

In the case of vehicles, such as, for example, in the case of motorcycles, rear view mirror arrangements are known which are mounted so as to be fixed on the handlebar and have a bowl-shaped mirror housing. A solid supporting plate for the mirror glass is arranged inside the bowl-shaped housing, which supporting plate is screwed on one hand fixedly to the housing. On the other hand, the mirror glass is glued as a non-supporting element with double-sided adhesive tape onto this supporting plate. The supporting plate is therefore formed as a self-supporting or dimensionally stable element and correspondingly has a comparatively high weight which can have a negative effect on the driving characteristics of the vehicle as a result of an eccentric position on the entire vehicle.

Rear view mirror arrangements are furthermore available which have a bowl-shaped mirror housing with integrated dome-shaped extensions in the housing interior, wherein a mirror glass is glued with hot adhesive directly onto the dome-shaped extensions. These rear view mirror arrangements have a particularly low weight as a result of the simplified design. However, the gluing generally has a certain degree—if very low degree—of elasticity, as a result of which at least the smallest relative movements of the mirror glass with respect to the housing are possible. Vibrations during vehicle operation accordingly lead to unintentional vibrations of the mirror glass. Especially when vibrations occur in the range of the inherent frequency of the mirror glass, resonances can occur and particularly significantly impair a use of the rear view mirror.

One object of the invention is therefore to further develop a rear view mirror of a vehicle in such a manner that at least one or more of the stated disadvantages of the prior art are avoided or at least reduced.

This object is achieved with a rear view mirror arrangement for a vehicle, as well as a vehicle having such a mirror arrangement, according to the features of the independent claims. Advantageous embodiments will become apparent from the claims respectively dependent thereon.

There is accordingly proposed a rear view mirror arrangement for a vehicle with a mirror element and a housing that accommodates the mirror element. The housing has an inner surface, on which at least one fastening extension is formed, and the mirror element is connected with a rear side that faces the inner surface to the at least one fastening extension. The mirror element is furthermore connected to a support element which is formed on the housing for support at least in some portions.

All land, water and air craft which have a corresponding rear view mirror arrangement are possible in principle as vehicles in the context of this description. The rear view mirror arrangement can thus also be used for water craft, such as boats. In the case of land craft, use both in the case of motor-driven motor vehicles and in the case of non-driven vehicles, such as bicycles, can be realized. In addition to passenger vehicles and heavy goods vehicles, use is also possible in the case of other motor-driven vehicles, such as, for example, wheelchairs, snowmobiles, three-wheelers or quads as well as preferably in the case of what are known as tilting vehicles. The term tilting vehicle refers, among other things, to motorbikes or motorbike-like motor vehicles, such as motor scooters, in particular two-, three- or four-wheeled motor scooters which are capable of tilting, scooters or the like.

The mirror element comprises in particular a mirror glass with a mirror surface for providing a mirror effect and is connected on its rear side directly or indirectly to one or several fastening extensions. These are provided on the inner surface of the housing and can be formed and produced integrally or in one piece with the inner surface or with the housing. Alternatively, the fastening extensions and the housing can be produced separately from one another and subsequently connected to one another.

The rear side of the mirror element should be understood in particular as the surface of the mirror element which is not intended for use of the mirror surface and faces a housing interior. The housing interior is defined in particular by an inner chamber or cavity enclosed fully or at least partially by the housing. For example, the housing can be formed to be bowl-shaped so that the housing interior is defined by the inner chamber delimited by a housing wall.

The support element is additionally provided which, on one hand, is connected to the mirror element and is arranged, on the other hand, only in some portions or fully circumferentially at an edge of the mirror element in order to be supported on the housing.

In order to provide support, the support element can be dimensioned and configured in such a manner that the support element is connected in the installed state in a positive locking manner to the housing. The positive locking is preferably formed between the support element and the inner surface of the housing. In this manner, an accurately fitting and play-free connection is achieved which makes it possible to avoid or at least reduce even small relative movements between the support element and the housing. The mirror element connected to the support element correspondingly profits from this.

The mirror element and the housing are already locally connected to one another via the fastening extensions. However, if (residual) elasticity of this connection is not to be avoided, relative movements, in particular in the form of vibrations, can occur. In this case, these relative movements can be effectively counteracted with the aid of the additional support element by virtue of the fact that the mirror element is supported with the aid of the support element additionally on the housing or on its inner surface. The mirror element thus also remains usable even in the event of the occurrence of vibrations during operation of the vehicle.

This structure offers the possibility that a separate, solid glass supporting plate which is also complex to screw in place according to the prior art can be dispensed with, as a result of which additional mass and weight are omitted.

As described, the support element can be connected to the rear side of the mirror element. This connection can preferably be performed in a materially bonded manner, in particular by gluing. Alternatively or additionally, a non-positive and/or positive connection of the support element to the rear side of the mirror element is possible.

The support element itself can be manufactured, for example, from plastic or a metallic material.

The support element can preferably at least in some portions be formed to be plate-shaped and have an edge portion which projects at least in some portions beyond an edge of the mirror element in order to support the support element on the inner surface of the housing.

This means that the support element can be formed substantially as a flat, planar component.

In order to achieve as low a weight as possible of the support element, a thickness of the plate-shaped portion of the support element can be small in comparison with a full-surface extension. The thickness can be, for example, less than 5 mm, preferably less than 2 mm, particularly preferably less than 1 mm.

The projection of the support element beyond the edge of the mirror element can be dimensioned such that the mirror element in this edge region is not in contact with the housing and instead a gap remains between the mirror element and the housing. This gap can be provided only in some portions or entirely circumferentially along an edge of the mirror element. For example, the projection of the support element with respect to the edge of the mirror element can be less than 5 mm, preferably less that 2 mm, particularly preferably less than 1 mm.

In other words, the projection of the support element enables that the support element can be accommodated and mounted in an accurately fitting and positive-locking manner in the housing, whereas the mirror element in its edge region itself has no contact with the housing. In this manner, greater tolerances which can occur during manufacture of the mirror element can also be easily balanced out. A direct and permanent connection of an edge of the mirror element to the housing would in contrast be difficult to provide as a result of large manufacturing tolerances during production of mirror glasses.

The support element therefore acts as an intermediate adapter plate and fixes the mirror element in the desired position as a result of its own accurately fitting connection to the housing and thus effectively prevents its relative movements with respect to the housing.

According to one embodiment, the edge portion of the support element can have a conical shape. For example, the edge portion can form a flange or extension which is oriented in each case perpendicular to a plane defined by the mirror element and is embodied to be tapered in this direction. This enables exact and accurately fitting contact with the inner surface of the housing.

Moreover, the connection between the support element and the rear side of the mirror element can be formed over the whole surface at least in some portions. This means that the support element is in full-surface connection with the rear side of the mirror element in one or more portions or entirely with a surface facing the mirror element. The connection is preferably embodied as a materially bonded connection, for example, by gluing, preferably by full-surface gluing, for example, by double-sided adhesive tape or double-sided adhesive foil.

The above-mentioned alternative or additional positive and/or non-positive connection or any desired combination of the three stated connection types for connection of the support element to the mirror element is also of course possible in the case of the full-surface connection between support element and mirror element.

Moreover, the support element can have at least one recess which is arranged in such a manner that the support element is recessed at least in a connection portion which is formed in each case by the connection of the rear side of the mirror element to the at least one fastening extension.

This offers the possibility that the rear side of the mirror element has, despite a (potentially full-surface) connection to the support element, one or more free portions in which the rear side of the mirror element can be connected directly to the fastening extensions.

Alternatively, the mirror element can be connected indirectly via the support element to the fastening extensions. In this case, the support element is applied on the rear side of the mirror element, which support element is in turn connected to the at least one fastening extension. In this case, it is possible that the support element fully covers the rear side of the mirror element over the entire surface.

Moreover, the support element can be formed to be non-self-supporting. This means, for example, that the support element itself is not formed to be dimensionally stable or at least not in its entirety so that the support element does not provide the mirror element with any additional load-bearing capacity or rigidity. Instead, the mirror element is used as a supporting element.

Moreover, the support element can have a stiffening rib structure. The rib structure is provided, for example, in the edge region of the support element in order to provide a dimensionally stable geometry at least of the edge region of the supporting element in order to ensure reliable support on the housing.

In terms of the connection of the mirror element to the housing, the connection of the rear side of the mirror element to the at least one fastening extension can be formed in a materially bonded and/or positive and/or non-positive manner. For example, the connection can be performed in a simple manner by means of hot adhesive or liquid adhesive.

According to one embodiment, the at least one fastening extension can have a connecting surface for full-surface connection to the rear side of the mirror element at a free end arranged distant from the inner surface. For example, the at least one fastening extension can be formed to be dome-shaped, rib-shaped or as what is known as a sliding platform (therefore as geometry generated by a slide from the side wall of the housing) or as a retainer.

In summary, a rear view mirror arrangement can therefore be provided which has improved vibration properties as a result of the (edge-side) support of the mirror element by means of the support element. Moreover, a low weight of the rear view mirror arrangement can be ensured with the aid of the described structure and thus a negative influencing of the driving characteristics of the entire vehicle can be prevented. The structure furthermore enables simple mounting, among other things, as a result of the omission of screwing in place alongside simultaneously low material requirements. A further advantage lies in the tension-free mounting of the mirror element which is enabled without the formation of tension as a result of the described structure of the rear view mirror arrangement.

A vehicle with at least one rear view mirror arrangement is furthermore proposed, wherein the at least one rear view mirror arrangement is formed according to this description.

The invention is explained in greater detail below on the basis of an exemplary embodiment with reference to the drawings.

### BRIEF DESCRIPTION OF THE DRAWINGS

FIG. 1 is an exploded view of a rear view mirror arrangement according to the

description;

FIG. 2 shows a combination of support element and mirror element for the rear view mirror arrangement according to FIG. 1; and

FIG. 3 is a sectional view of the rear view mirror arrangement according to FIG. 1.

### DETAILED DESCRIPTION OF THE DRAWINGS

FIG. 1 shows a rear mirror arrangement 10 for a vehicle (not represented) according to the description in an exploded view. Rear view mirror arrangement 10 accordingly comprises a mirror element 11 and a housing 12 that accommodates mirror element 11 and which can be fastened to the vehicle via a rod-shaped holder 18.

Mirror element 11 is formed in the represented embodiment by a mirror glass which provides a mirror surface.

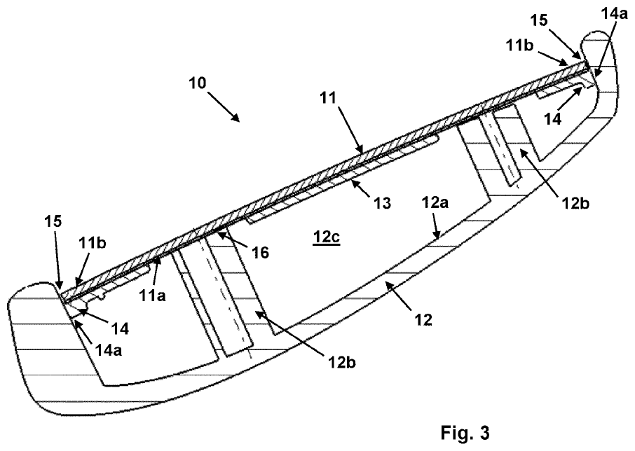

Housing 12 is formed to be substantially bowl-shaped and has an inner surface 12a on which four fastening extensions 12b are formed, wherein fastening extensions 12b are provided to be connected to a rear side 11a of mirror element 11 facing inner surface 12a (cf. FIG. 3). For this purpose, fastening extensions 12b are embodied to be dome-shaped and have a connecting surface for full-surface connection to rear side 11a of mirror element 11 at a free end arranged remote from inner surface 12a. This connection can be formed in a materially bonded and/or positive and/or non-positive manner, preferably by means of hot adhesive or liquid adhesive.

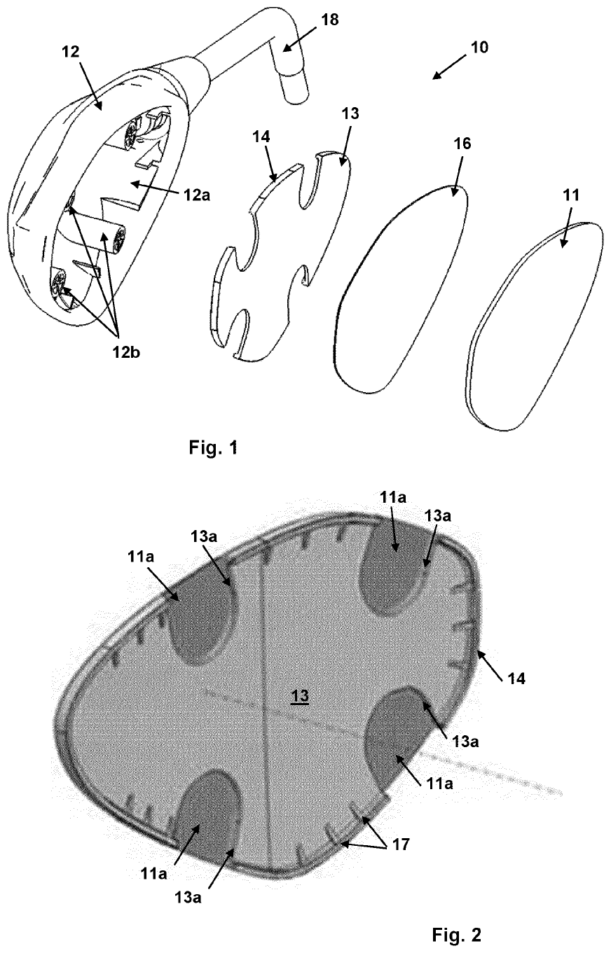

Mirror element 11 is furthermore connected to a support element 13 (see FIGS. 2 and 3) which is formed for support on housing 12 at least in some portions.

Support element 13 is formed to be plate-shaped and has an edge portion 14 which projects—as is apparent in FIG. 3—over an edge 11b of mirror element 11 in order to support the support element 13 on inner surface 12a of housing 12. As a result of the projection of support element 13 beyond edge 11b of mirror element 11, it is achieved that mirror element 11 is not in contact with housing 12 in this edge region and instead a gap 15 remains between mirror element 11 and housing 12. This gap 15 is provided circumferentially along edge 11b of mirror element 11.

The projection of support element 13 with respect to edge 11b of mirror element 11 can be, for example, less than 5 mm, preferably less than 2 mm.

As is apparent in particular from FIG. 3, support element 13 is accommodated and mounted in an accurately fitting and positive manner in housing 12 due to the projection. Mirror element 11 itself has no (direct) contact with housing 12 in its edge region.

Edge portion 14 of support element 13 additionally has a conical shape. Edge portion 14 forms a flange 14a or extension which is oriented perpendicular to a plane defined by mirror element 11 and is embodied to be tapered in this direction (i.e. in the direction of housing interior 12c). Support element 13 can thus be easily moved into the desired position and brought there into accurately fitting contact with inner surface 12a of housing 12.

Support element 13 is, according to the represented embodiment, connected over the whole surface to a large portion of rear side 11a of mirror element 11. The connection can be provided in a materially bonded manner, for example by full-surface gluing by means of double-sided adhesive foil 16.

Support element 13 additionally has several recesses 13a (four recesses 13a are represented by way of example) which are arranged in such a manner that support element 13 is recessed at least in a respective connecting portion which is formed in each case by the connection of rear side 11a of mirror element 11 to respective fastening extension 12b. Rear side 11a of mirror element 11 can thus be connected directly to fastening extensions 12b despite the otherwise full-surface connection to support element 13 in these free portions.

Support element 13 additionally has a stiffening rib structure 17. Rib structure 17 is provided in edge region 14 of support element 13 in order to ensure a dimensionally stable geometry at least of edge region 14 of support element 13 for reliable support on housing 12.

1-8. (canceled)

9. A rear view mirror arrangement for a vehicle, comprising:
a mirror element;
a housing that accommodates the mirror element,
wherein the housing has an inner surface, on which at least one fastening extension is formed, and the mirror element is connected with a rear side that faces the inner surface to the at least one fastening extension; and
a support element which is supported on the housing for support of the mirror element at least in some portions, wherein the mirror element is connected to the support element.

10. The rear view mirror arrangement according to claim 9, wherein
the support element is plate-shaped at least in some portions and has an edge portion which projects at least in some portions beyond an edge of the mirror element so that the support element is supported on the inner surface of the housing.

11. The rear view mirror arrangement according to claim 10, wherein
the edge portion of the support element has a conical shape.

12. The rear view mirror arrangement according to claim 9, wherein
the connection between the support element and the rear side of the mirror element is formed over an entire surface area of the rear side at least in some portions.

13. The rear view mirror arrangement according to claim 9, wherein
the support element has at least one recess located in a connecting portion of, in each case, the connection of the rear side of the mirror element to the at least one fastening extension.

14. The rear view mirror arrangement according to claim 9, wherein the support element is formed to be non-self-supporting.

15. The rear view mirror arrangement according to claim 9, wherein the support element has a stiffening rib structure.

16. A vehicle comprising at least one rear view mirror arrangement according to claim 9.
